(19) United States
(12) Patent Application Publication
(10) Pub. No.: US 2025/0328058 A1
(43) Pub. Date: Oct. 23, 2025

(54) ACTUATOR FOR CAMERA

(71) Applicant: JAHWA electronics Co., Ltd., Chungcheongbuk-do (KR)

(72) Inventor: CHANG WOOK PARK, Incheon (KR)

(21) Appl. No.: 18/870,761

(22) PCT Filed: Dec. 7, 2023
(86) PCT No.: PCT/KR2023/020095

§ 371 Date: Dec. 2, 2024

(30) Foreign Application Priority Data
Jan. 2, 2023 (KR) 10-2023-0000202

(51) Int. Cl. G03B 13/36; G02B 27/64; G03B 5/00

(52) U.S. Cl. CPC G03B 13/36; G02B 27/64; G03B 5/00; G03B 2205/0007; G03B 2205/0069

(57) ABSTRACT

An actuator for a camera includes a carrier on which a magnet is installed, a base configured to accommodate the carrier, a coil configured to face the magnet, and a back yoke provided at a rear of the magnet and installed on the carrier. The back yoke includes a body plate provided at the rear of the magnet, and a cover configured to protrude from the body plate toward the coil to cover a side surface of the magnet while forming a gap with the side surface of the magnet.

### BACKGROUND

### 1. Technical Field

The present invention relates to an actuator for a camera, and more specifically, to an actuator for a camera having improved driving performance through structural improvement of a back yoke.

### 2. Background Art

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

An optical image stabilization (OIS) function means a function of improving the sharpness of an image by adaptively moving the carrier having a lens in a direction to compensate for the shaking when the lens is shaken due to trembling.

One of the representative methods for implementing autofocus or OIS function is to install a magnet (coil) on a moving body (carrier) and install a coil (magnet) on a fixed body (housing, base, or other types of carrier), and then generate an electromagnetic force between the coil and the magnet to move the moving body in the optical axis direction or in a direction perpendicular to the optical axis.

Since this driving method utilizes the magnetic force or electromagnetic force between the coil and the magnet, a greater driving force may be realized as the size of the coil or/and magnet facing each other increases or their facing area expands.

However, a camera actuator with OIS functions, etc. is mounted on a mobile terminal (such as a smartphone) that has essential elements such as slimness and lightness, so it is subject to physical constraints such as thickness and volume. Therefore, the size of the magnet, etc. cannot be expanded without limitation to increase driving force, etc.

Furthermore, considering that the weight and volume of the mounted lens are increasing as the demand for high-spec camera modules increases, an increased driving force is required, and an expanded space is also required in which a high-spec lens can be mounted while maintaining the overall volume, so the spatial efficiency of the camera actuator may become an increasingly important issue.

Meanwhile, in the case of an actuator in which AF and OIS are integrated according to an embodiment, an AF frame (such as an AF carrier) that implements AF and an OIS frame (such as an OIS carrier) that mounts the AF frame or is mounted on the AF frame are typically provided together. In this case, magnetic interference may occur between the AF magnet installed on the AF frame and the OIS magnet installed on the OIS frame.

If magnetic interference occurs between adjacent magnets as above or if the magnets are mutually influenced by their magnetic forces, the linear relationship between position detection and resulting position control is broken, so the driving performance itself, which is precisely feedback-controlled, may deteriorate.

Moreover, when magnetic interference occurs, posture errors such as rotation and tilt are induced in each carrier, especially in the OIS carrier that moves slightly, so the driving precision of the OIS may be reduced in this respect as well.

### SUMMARY

These and other objects and advantages of the present disclosure may be understood from the following detailed description and will become more fully apparent from the exemplary embodiments of the present disclosure. Also, it will be easily understood that the objects and advantages of the present disclosure may be realized by the means shown in the appended claims and combinations thereof.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

In one aspect of the present disclosure, there is provided an actuator for a camera, including: a carrier on which a magnet is installed: a base configured to accommodate the carrier: a coil configured to face the magnet; and a back yoke provided at a rear of the magnet and installed on the carrier.

In this case, the back yoke of the present disclosure may include a body plate provided at the rear of the magnet; and a cover configured to protrude from the body plate toward the coil to cover a side surface of the magnet while forming a gap with the side surface of the magnet.

Here, the carrier of the present disclosure may include a first carrier configured to move in an optical axis direction and having an AF magnet installed thereon; and a second carrier configured to move in a plane direction perpendicular to an optical axis and having an OIS magnet installed thereon, and in this case, the back yoke may be provided at a rear of the OIS magnet.

In addition, the OIS magnet of the present disclosure may be provided in plurality at orthogonal positions, and the back yoke is preferably provided at a rear of an OIS magnet that is disposed at a position close to the AF magnet among the plurality of OIS magnets.

The actuator for a camera of the present disclosure may further include a pulling yoke configured to generate an attractive force with the OIS magnet, and in this case, the cover may be configured to cover side surfaces of the OIS magnet except for a side surface of the OIS magnet facing the pulling yoke so that a part of the OIS magnet facing the pulling yoke is exposed.

Depending on an embodiment, a part of the cover that is disposed in a direction toward the pulling yoke preferably has one or more holes or openings formed therein.

According to a preferred embodiment of the present disclosure, the leaked magnetic field may be reduced through structural improvement of the back yoke that induces magnetic field concentration of the magnet, and further enhanced driving force may be provided in the relationship between the magnet and the coil facing the magnet.

Since the driving force may be increased based on magnets of the same specification in this way, the entire structure and shape of the actuator may be implemented in a more space-intensive form, which not only minimizes the overall space, but may also be further optimized for miniaturization of mobile terminals.

According to an embodiment of the present disclosure, the magnetic interference between the AF magnet and the OIS magnet, which is installed at a position relatively close to the AF magnet among the magnets for driving in each direction of the OIS, may be reduced, so that the independence of the OIS driving, which is particularly finely driven, may be more effectively implemented.

According to an embodiment of the present disclosure, the driving force may be increased in the relationship between the magnet and the coil, and also the efficiency of the attractive force between the magnet and the pulling yoke for contact efficiency with the ball means may be simultaneously improved.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a drawing showing the overall configuration of an actuator for a camera according to a preferred embodiment of the present disclosure,

FIGS. 2 and 3 are exploded views showing a detailed configuration of the actuator for a camera according to a preferred embodiment of the present disclosure,

FIG. 4 is a diagram showing a detailed configuration of a second carrier (OIS carrier) according to an embodiment of the present disclosure,

FIGS. 5 and 6 are diagrams for illustrating a structural relationship between a back yoke and a magnet,

FIG. 7 is a diagram showing an embodiment of the back yoke, and

FIG. 8 is a diagram showing a structural relationship between a magnet and a pulling yoke.

### DETAILED DESCRIPTION

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

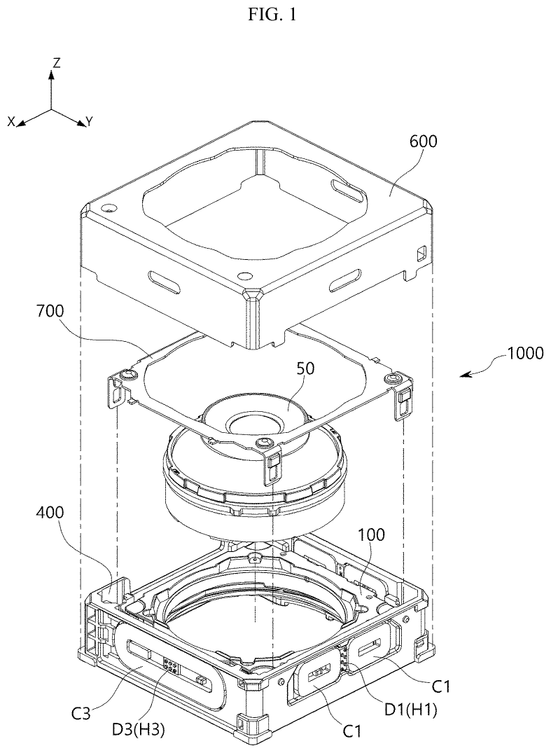

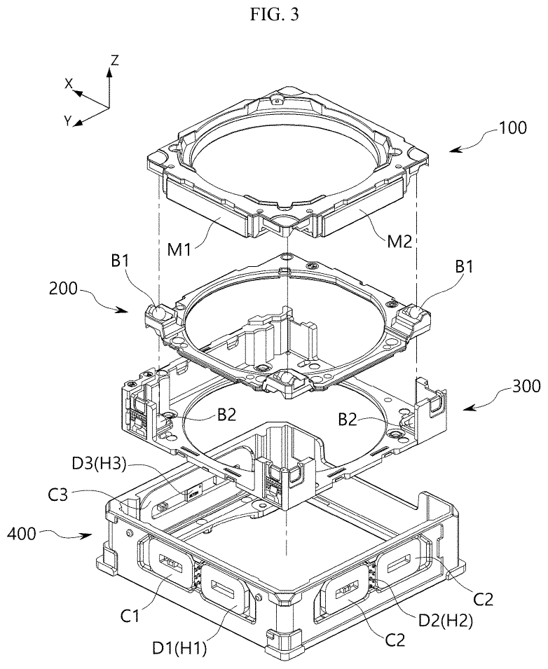

FIGS. 1 to 3 are drawings showing the overall configuration and detailed configuration of an actuator 1000 for a camera (hereinafter referred to as “actuator”) according to the present disclosure.

The actuator 1000 of the present disclosure illustrated in FIG. 1 and other accompanying drawings is an embodiment in which AF and OIS are implemented together, but of course, the actuator 1000 of the present disclosure may be implemented as an actuator for OIS or only for AF depending on the embodiment.

Also, the actuator 1000 of the present disclosure may be implemented as a single device, and may also be implemented in the form of a camera module including a lens 50 and an image sensor (not shown).

The actuator 1000 of the present disclosure may include a base 400 that corresponds to a basic frame of the actuator 1000 as illustrated in FIG. 1 and provides an internal space, and a case 600 that is coupled to the base 400 from the above and functions as a shield can.

The carrier 100 of the present disclosure may be an AF carrier (first carrier) moving in the optical axis direction or an OIS carrier (second carrier) moving in a direction perpendicular to the optical axis. The following description is based on an embodiment in which the carrier 100 is an OIS carrier (second carrier) moving in a direction perpendicular to the optical axis. However, it will be understood that the carrier 100 may also be a carrier implementing AF within the scope to which the technical idea of the present disclosure is applicable.

The axes shown in the drawings, terms referring to the axes, and terms such as top, bottom, front, rear, vertical, horizontal, etc. described with respect to the axes are intended to present relative standards for describing embodiments of the present disclosure, and, it is self-evident that these terms are not intended to specify any direction or location on an absolute basis, and of course, these terms may vary relatively depending on the location of a target object, the location of an observer, a viewing direction, etc.

Hereinafter, in describing the present disclosure, the direction axis corresponding to the path through which light is introduced into the lens or lens assembly 50 (hereinafter, referred to as a ‘lens’), namely the direction axis corresponding to the vertical longitudinal direction of the lens 50, is defined as an optical axis (Z-axis), and two axes on the plane perpendicular to this optical axis (Z-axis) are defined as X-axis and Y-axis.

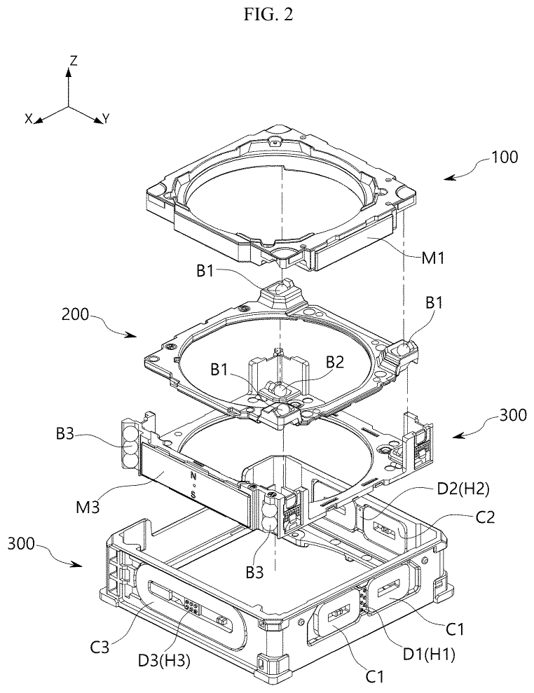

As illustrated in FIG. 2, the actuator 1000 of the present disclosure may include an OIS carrier 100, a middle guide 200, an AF carrier 300, etc.

The OIS carrier 100 may have OIS magnets M1 and M2 installed on one side surface or two side surfaces orthogonal to each other, and drive coils C1 and C2 facing the OIS magnets M1 and M2 installed on the OIS carrier 100, respectively, are disposed on the base 400.

Hereinafter, the OIS magnet installed at one side (X-axis direction) of the OIS carrier 100 is referred to as a first magnet M1, and the OIS magnet installed in a direction orthogonal to the first magnet M1 is referred to as a second magnet M2. In addition, correspondingly, the drive coil facing the first magnet M1 is referred to as a first coil C1, and the drive coil facing the second magnet M2 is referred to as a second coil C2.

The middle guide 200 may be disposed below the OIS carrier 100 based on the optical axis direction to induce linear movement of the OIS carrier 100, and a first ball B1 is disposed between the OIS carrier 100 and the middle guide 200. In addition, the middle guide 200 on which the OIS carrier 100 is mounted is accommodated in the AF carrier 300, and a second ball B2 is disposed between the middle guide 200 and the AF carrier 300.

If power of an appropriate size and direction is applied to the drive coils C1 and C2 by the control of the operation drivers D1 and D2, an electromagnetic force (magnetic force) is generated between the drive coils C1 and C2 and the magnets M1 and M2 facing the drive coils C1 and C2, and the OIS carrier 100 on which the lens 50 is mounted moves in the combined direction of the X-axis direction and the Y-axis direction perpendicular to the optical axis by the generated electromagnetic force, thereby correcting shaking caused by hand trembling.

The middle guide 200 is a component to further improve the precision of linear movement in the X-axis and Y-axis directions. If an electromagnetic force in the X-axis direction is generated by the drive coils C1 and C2, the OIS carrier 100 with the lens 50 mounted thereon moves in the X-axis direction using the middle guide 200 as a relatively fixed body.

In addition, if an electromagnetic force in the Y-axis direction is generated by the drive coils C1 and C2, the OIS carrier 100 moves in the Y-axis direction together with the middle guide 200 due to the directionality (X-axis direction) and the physical coupling structure of the rail that guides the first ball B1.

Since the first ball B1 and the second ball B2 are disposed between the middle guide 200 and the OIS carrier 100 and between the middle guide 200 and the AF carrier 300, respectively, the movement in each direction is supported and achieved by these balls B1 and B2.

If the ball is interposed as above, the mover may linearly move more flexibly due to the minimized friction caused by the ball's rolling, moving, rotation, and point-contact with the facing object, and also there is an advantage of reducing noise and minimizing driving force, as well as improving driving precision.

In order to implement effective guiding of linear movement, it is preferable that the first ball B1 is configured to be partially is accommodated in at least one of the rails formed on the lower portion of the OIS carrier 100, etc., and/or the rails formed on the upper portion of the middle guide 200, etc.

In a corresponding view, the second ball B2 may be configured to be partially accommodated in at least one of the rails formed on the lower portion of the middle guide 200 and/or the rails formed on the AF carrier 300.

According to an embodiment, the actuator may further include hall sensors H1 and H2 that detect changes in the size and direction of a magnetic field of a magnet existing within a detection area using the hall effect and output electrical signals accordingly to the operation drivers D1 and D2.

The operation driver may be implemented as an independent electronic component, element, etc., but may also be implemented as a single electronic component (chip) integrated with the hall sensor through SOC (System On Chip), etc. Therefore, in the drawings, the hall sensors H1 and H2 and the operation drivers D1 and D2 for each direction are indicated in the same configuration.

In addition, the operation driver may be provided in the same number as individual hall sensors and implemented as a single chip with each individual hall sensor. However, depending on the embodiment, the number of channels for electrical connection with the hall sensors may be adjusted, etc., so that the operation driver may not be provided in the same number as individual hall sensors, and may be implemented as a single chip with some of the individual hall sensors.

The AF carrier 300 of the present disclosure accommodates the OIS carrier 100 and the middle guide 200, which are arranged vertically based on the optical axis direction, and corresponds to a moving body that moves linearly in the optical axis direction based on the base 400.

Even in this case, if the third hall sensor H3 detects the position of the AF magnet M3, which is the drive magnet for AF, and outputs a signal corresponding thereto to the third operation driver D3 as described above, the third operation driver D3 controls power of an appropriate size and direction to be applied to the AF coil C3, which is the drive coil for AF, thereby causing the AF carrier 300 to move linearly in the optical axis direction.

A third ball B3 is disposed between the rail formed on the outer surface of the AF carrier 300 and the rail formed on the inner surface of the base 400 to guide the linear movement (optical axis direction) of the AF carrier 300.

Depending on an embodiment, the actuator of the present disclosure may include a stopper 700 that limits the movement of the OIS carrier 100, etc. in the Z-axis direction and guides the movement in the X-axis direction or/and the Y-direction, so that the deviation phenomenon, such as the separation or lifting of the OIS carrier 100 and/or the middle guide 200 in the Z-axis direction, may be suppressed, when the OIS is driven.

The first coil C1, the second coil C2, and the AF coil C3, etc. described above may be provided to be mounted on a single circuit board or a plurality of circuit boards (not shown) provided on the outer surface of the base 400, and depending on an embodiment, the actuator 1000 of the present disclosure may include a yoke plate (not shown) that is provided on the outer side of the base 400 to generate an attractive force to the AF magnet M3.

Since the AF carrier 300 mediated by the third ball B3 is pulled toward the base 400 (X-axis direction based on the drawing) by the attractive force between the yoke plate and the AF magnet M3, contact between the third ball B3 and the AF carrier 300 and between the third ball B3 and the base 400 may be continuously maintained.

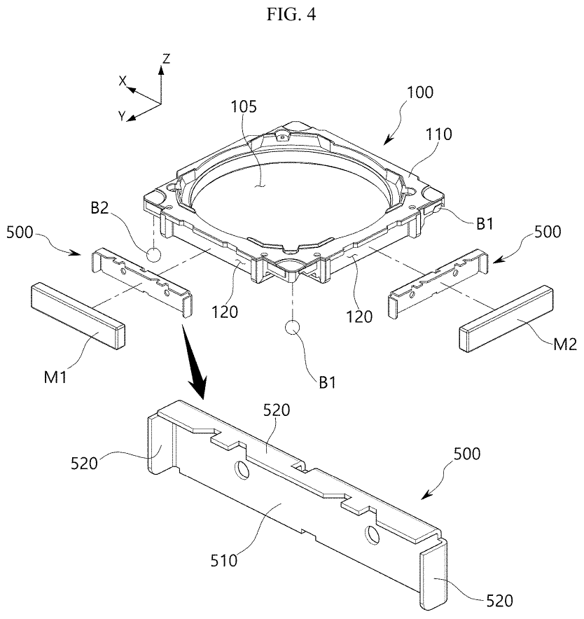

FIG. 4 is a diagram showing a detailed configuration of a second carrier (OIS carrier) 100 according to an embodiment of the present disclosure,

The second carrier 100 according to an embodiment of the present disclosure includes a body 110 having a mounting space 105 formed in the center portion in which a lens 50 is mounted, and a mounter 120.

The mounter 120 is a space where the first magnet M1 and second magnet M2, etc. are mounted, and is formed on the side surface of the body 110. Here, as shown in the drawings, it is preferable that the first magnet M1 and second magnet M2 are formed in directions orthogonal to each other based on the direction of the plane (XY plane) perpendicular to the Z-axis.

It is desirable that the mounter 120 is configured to have an open shape in the lower direction (based on the Z-axis direction). If the lower portion of the mounter 120 is open in this way, the ease of installation and the space securing may be implemented more effectively, and also the attractive force efficiency with the pulling yoke 800 installed on the first carrier 300 may be improved.

In order to increase the position fixing force of the magnets M1 and M2 and to increase the efficiency of assembly processes such as alignment, it is preferable that the mounter 120 is configured so that its side surface is inserted into the interior of the OIS carrier 100 as shown in the drawing so as to serve as a kind of guiding wall.

The back yoke 500 of the present disclosure is provided at the rear of the first (second) magnet M1, M2, namely in the opposite direction in which the first magnet M1 faces the first coil C1, and is installed on the mounter 120 together with the first magnet M1.

The back yoke 500 is a component made of a magnetic material for preventing magnetic leakage and concentrating magnetic force, and may be configured to be partially or fully embedded in the mounter 120 through insert injection molding, etc., depending on the embodiment.

Specifically, the back yoke 500 is provided at the rear of the first magnet M1 (negative Y-axis direction based on FIG. 4), and includes a body plate 510 that functions as the body of the back yoke 500, and a cover 520.

The cover 520 of the back yoke 500 is configured to protrude from the body plate 510 toward the first coil C1 by means of bending, bonding, pressing, etc. to cover the side surface of the first magnet M1. The back yoke 500 provided at the rear of the second magnet M2 also has the same configuration, and will not be described in detail.

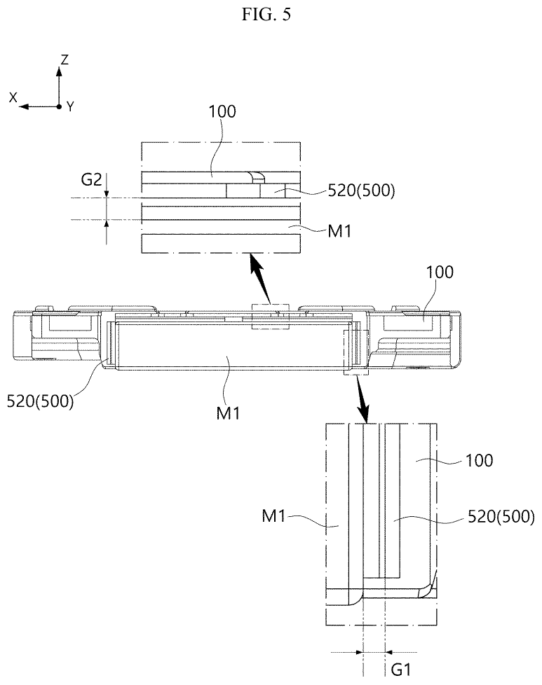

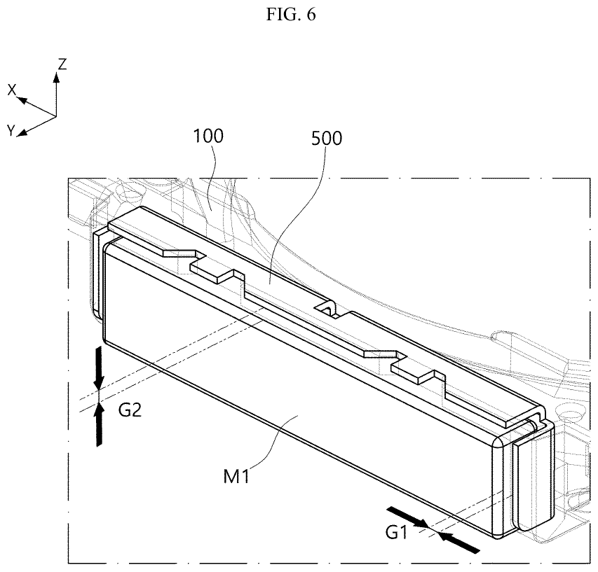

FIGS. 5 and 6 are diagrams for illustrating a structural relationship between a back yoke 500 and a magnet. Hereinafter, the specific configuration of the back yoke 500 of the present disclosure is described in detail with reference to the drawings.

The cover 520 of the back yoke 500 is configured to cover the side surface of the first magnet M1. As shown in the drawings, it is preferable that the cover 520 is configured to be spaced apart from the side surface of the first magnet M1 by a predetermined distance so that gaps G1 and G2 are formed with the side surface of the first magnet M1.

The magnetic field of a magnet has a curved shape and is formed in a three-dimensional space. When a magnetic body exists at an appropriate location adjacent thereto, the line of magnetic force has a behavior characteristic of extending or expanding to a position where the magnetic body is located.

Therefore, if the cover 520 of the back yoke 500 is installed to cover the side surface of the first magnet M1 but is spaced apart therefrom as shown in the drawings, the magnetic field formed in the first magnet M1 extends toward the cover 520, which is a neighboring magnetic body. Since this magnetic field extension phenomenon is induced based on the entire three-dimensional space, the electromagnetic force (magnetic force) may be enhanced in relation to the facing first coil C1.

Therefore, even if a smaller magnet is used compared to a magnet of the same specifications, the smaller magnet may have the same or greater magnetic force (electromagnetic force), thereby increasing the driving efficiency in relation to the coil.

Since the magnet is a component provided in the moving body (AF, OIS), in the embodiment of the present disclosure, a relatively small-sized magnet may be used, which may reduce the weight of the moving body and thereby further improve the driving efficiency.

In addition, since a relatively small-sized magnet is used, the leakage magnetic field may also be lowered, which may also reduce magnetic interference between adjacent magnets.

Therefore, if the actuator 1000 is an actuator that combines AF and OIS, it may be more desirable that the back yoke 500 having the above structure is provided at the rear of the OIS magnet located close to the AF magnet among the OIS magnets.

Based on the embodiment illustrated in the drawings, since the first magnet M1 is closer to the AF magnet M3 than the second magnet M2, the back yoke 500 of the above-described structure may be provided at the rear of the first magnet M1.

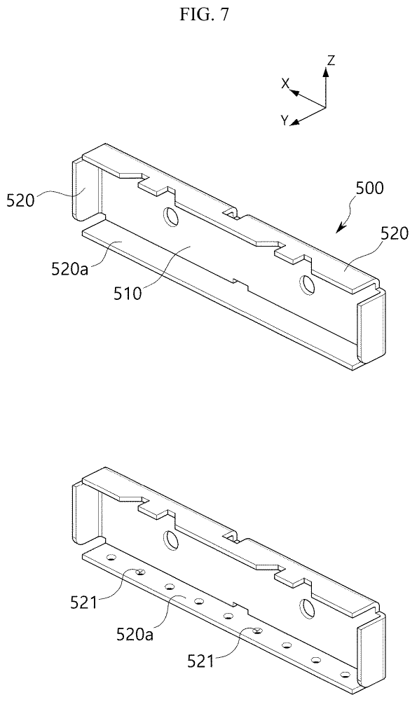

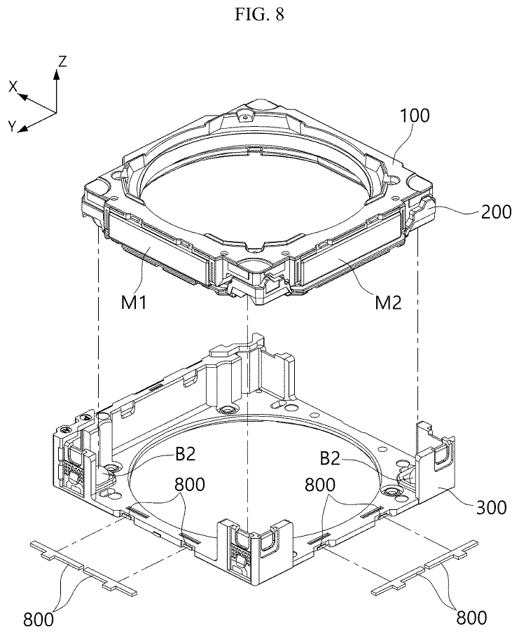

FIG. 7 is a diagram showing an embodiment of the back yoke 500, and FIG. 8 is a diagram showing a structural relationship between the magnets M1 and M2 and the pulling yoke 800.

As illustrated in FIG. 7, the cover 520 of the back yoke 500 may be implemented in a form that covers the entire side surface of the first magnet M1, and depending on an embodiment, it is preferable that the cover 520a located at the lower portion (based on the Z-axis) is configured to have one or more holes or openings 521 formed as illustrated in the drawings.

The component (AF carrier (first carrier) 300 in the drawings of the present disclosure) functioning as a relative fixed body in relation to the OIS carrier (second carrier) 100 may include a pulling yoke 800 that generates an attractive force with the OIS magnets M1 and M2 and induces centering when the OIS operation is terminated.

The OIS carrier (second carrier) 100 is pulled toward the AF carrier 300 by the attractive force between the OIS magnets M1 and M2 and the pulling yoke 800, thereby improving the contact efficiency among the OIS carrier 100, the first ball B1, the middle guide 200, the second ball B2, and the AF carrier (first carrier) 300.

If the lower portion of the back yoke 500 is configured to be open as described above, namely when the cover 520 of the back yoke 500 is configured to cover the side surfaces of the OIS magnets M1 and M2 except for the side surface facing the pulling yoke 800 so that the part of the OIS magnets M1 and M2 facing the pulling yoke 800 is exposed, the reduction in attractive force between the OIS magnets M1 and M2 and the pulling yoke 800 may be minimized.

If the hole or opening 521 is formed in the lower cover 520a of the back yoke 500 that covers the side surface of the first magnet M1 as shown in the lower drawing of FIG. 7 according to the embodiment, the driving force generated in relation to the first coil C1 may be increased, and also the reduction in the attractive force with the pulling yoke 800 may be suppressed.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

1. An actuator for a camera, comprising:
a carrier;
a magnet installed on the carrier;
a base configured to accommodate the carrier;
a coil configured to face the magnet; and
a back yoke provided at a rear of the magnet and installed on the carrier,
wherein the back yoke includes:
a body plate provided at the rear of the magnet; and
a cover configured to protrude from the body plate toward the coil to cover a side surface of the magnet while forming a gap with the side surface of the magnet.

2. The actuator for a camera according to claim 1, wherein the carrier includes:
a first carrier configured to move in an optical axis direction and having an autofocusing (AF) magnet installed thereon; and
a second carrier configured to move in a plane direction perpendicular to an optical axis and having an optical image stabilization (OIS) magnet installed thereon,
wherein the back yoke is provided at a rear of the OIS magnet.

3. The actuator for a camera according to claim 2, wherein the OIS magnet is provided in plurality at orthogonal positions, and
wherein the back yoke is provided at a rear of an OIS magnet that is disposed at a position close to the AF magnet among the plurality of OIS magnets.

4. The actuator for a camera according to claim 2, further comprising:
a pulling yoke configured to generate an attractive force with the OIS magnet,
wherein the cover covers side surfaces of the OIS magnet except for a side surface of the OIS magnet facing the pulling yoke so that a part of the OIS magnet facing the pulling yoke is exposed.

5. The actuator for a camera according to claim 2, further comprising:
a pulling yoke configured to generate an attractive force with the OIS magnet,
wherein a part of the cover that is disposed in a direction toward the pulling yoke has one or more holes or openings formed therein.
